(19) United States
(12) Patent Application Publication
(10) Pub. No.: US 2005/0018670 A1
(43) Pub. Date: Jan. 27, 2005

(54) Method for frame forwarding and network switch

(76) Inventors: Miwa Shigematsu, Kitakyushu (JP); Hiroki Tamura, Onojo (JP); Takato Ohashi, Fukuoka (JP); Naoshi Kayashima, Onojo (JP); Sayuri Matsuo, Kasuya-gun (JP)

Correspondence Address: SWIDLER BERLIN SHEREFF FRIEDMAN, LLP, 3000 K STREET, NW, BOX IP, WASHINGTON, DC, 20007, US

(21) Appl. No.: 10/800,750

(22) Filed: Mar. 16, 2004

(30) Foreign Application Priority Data
Jul. 24, 2003 (JP) 2003-279410

(51) Int. Cl. H04L 12/28

(52) U.S. Cl. 370/389

(57) ABSTRACT

The present invention provides a method for forwarding frames between Ethernet network nodes in which an output queue is provided for storing frames to be forwarded in the same direction, and more than one frame stored in the output queue are combined into a single frame, and the combined frame is then transmitted to the output port corresponding to that direction. With this configuration, packets encapsulated into a plurality of frames are stored in the output queue during transmission of the previous frames in the same direction or during their inter-frame gaps, and then combined into one packet, the combined packet being encapsulated into one frame to be transmitted. Accordingly, the amount of data that can be transmitted during a certain time period is increased by the amount equivalent to the reduced number of inter-frame gaps compared to when packets encapsulated into a plurality of frames are individually transmitted, thereby achieving more efficient frame forwarding.

### BACKGROUND OF THE INVENTION

1. Field of the Invention

The present invention relates to a frame forwarding method and a network switch used in an Ethernet network. More particularly, the invention relates to a frame forwarding method and a network switch in which efficient frame forwarding can be achieved by combining packets encapsulated in a plurality of frames to be forwarded in the same direction into a single packet.

2. Description of the Related Art

In frame forwarding in an Ethernet network, it is defined that predetermined intervals, which are referred to as “inter-frame gaps”, be disposed between frames. When continuously sending frames in which many relatively short packets are encapsulated, the efficiency in forwarding frames decreases due to the inter-frame gaps. Accordingly, there is a demand for efficient frame forwarding by inhibiting an adverse influence of the inter-frame gaps.

In a known packet switch network, for example, the following packet forwarding method is disclosed (see Japanese Unexamined Patent Application Publication Nos. 2-166856 (pages 3 to 5, and FIGS. 2 to 4) and 63-197148 (pages 2 and 3, and FIG. 3)). In this method, when forwarding packets from a packet switch device, packets having the same final destination are combined into a single packet before being forwarded so as to reduce the amount of information concerning the headers of the packets, thereby increasing the efficiency in forwarding packets.

In switching packets between nodes forming a known Ethernet network, packets are encapsulated into frames in the format defined by the Ethernet standards, and are then forwarded with predetermined inter-frame gaps. The packets are encapsulated into other frames every time they pass through a node, which forms a packet forwarding path, and are then delivered to the final destination.

FIG. 1 illustrates a known Ethernet frame forwarding method. In FIG. 1, packets P(1) and P(3) are to be delivered from a network 200a to a network 200b, and a packet P(2) is to be delivered from the network 200a to a network 200c. In this case, the forwarding paths of the packets P(1), P(2), and P(3) are indicated by the arrows in broken lines. In FIG. 1, only the packets are shown, though they are actually encapsulated into frames.

Upon receiving the packets P(1), P(2), and P(3) from the network 200a via an input port 41, a network switch 100a specifies output ports corresponding to the packet destination addresses contained in the headers of the packets P(1), P(2), and P(3) by referring to the routing table stored in the network switch 100a, and then encapsulates the packets P(1), P(2), and P(3) into the corresponding frames and delivers them to the specified output ports. In the example shown in FIG. 1, the packets P(1), P(2), and P(3) are forwarded to an output port 42, which is linked to a network switch 100b.

Upon receiving the frames containing the packets P(1), P(2), and P(3) via an input port 43, the network switch 100b specifies output ports corresponding to the packet destination addresses contained in the headers of the received packets P(1), P(2), and P(3) by referring to the routing table stored in the network switch 100b, and encapsulates the packets P(1), P(2), and P(3) into the corresponding frames and delivers them to the corresponding output ports. In the example shown in FIG. 1, the packets P(1) and P(3) are forwarded to an output port 44, which is linked to the network 200b, and the packet P(2) is forwarded to an output port 45, which is linked to a network switch 100c.

Upon receiving the frame containing the packet P(2) via an input port 46, the network switch 100c specifies the output port corresponding to the packet destination address contained in the header of the received packet P(2) by referring to the routing table stored in the network switch 100c, and encapsulates the packet into a frame and delivers it to the corresponding output port. In the example shown in FIG. 1, the packet P(2) is forwarded to an output port 47, which is linked to the network 200c.

In Ethernet, it is defined that a minimal space equivalent to a 96-bit inter-frame gap be disposed between frames. The time interval corresponding to the inter-frame gap varies according to the data rate used in a network; for example, the inter-frame gap is 9.6 μs when the data rate is 10 Mbps. Accordingly, frames must be forwarded in an Ethernet network with inter-frame gaps having the above-described time interval or longer.

FIG. 2 illustrates the structure of an Ethernet frame in a known frame forwarding method.

The frame consists of a preamble 51, which is an 8-byte synchronizing signal, a destination address 52, which is 6-byte Ethernet address information indicating a frame destination node, a source address 53, which is 6-byte Ethernet address information indicating the node which sends the frame, a type 54, which is 2-byte ID code indicating the type of protocol for the packet stored in the data field of the frame, and a data field 55, which is the data delivered from a frame source node to a frame destination node, the length of the data field 55 being limited to 46 to 1500 bytes in Ethernet. The frame also contains a frame check sequence (FCS) 56, which performs a cyclic redundancy check (CRC) on the destination address 52, the source address 53, the type 54, and the data field 55, for detecting bit errors occurring when forwarding the frame. A packet 57 is encapsulated into the data field 55 of the frame and then forwarded among nodes in the network, reaching the node indicated by the destination address set in the header (not shown) of this packet. In FIG. 2, the numeric values in parentheses indicate the lengths of the corresponding fields of the frame in bytes.

FIG. 3 is a time chart illustrating a known frame forwarding method. In this time chart, packets P(1), P(2), and P(3) encapsulated into the data fields of the frames received from input ports 12a, 12b, and 12c, respectively, are re-encapsulated into frames, and are then transmitted from a output port 13a. In this example, ports that receive frames are input ports, and ports that transmit frames are output ports. In actuality, however, the frames can be transmitted and received by the same port.

Frames 61, 62, 63, 64, and 65 transmitted from the output port 13a are forwarded with inter-frame gaps 71, 72, 73, and 74 having 96 bits or more according to the Ethernet standards. In this example, the packets P(1), P(2), and P(3) encapsulated in the frames received by the input ports 12a, 12b, and 12c, respectively, are extracted in a time period T1 from when the transmission of the frame 62 is started to when the transmission of the subsequent frame 63 is started, and are re-encapsulated as the data fields of the frames 63, 64, and 65, respectively. Then, the frames 63, 64, and 65 are transmitted with the inter-frame gaps 72, 73, and 74 having 96 bits or more. In this manner, even when a plurality of packets are transmitted to the same output port, they are encapsulated in difference frames. Thus, when continuously sending short packets, the total amount of data that can be transmitted in a certain time period becomes smaller as the number of inter-frame gaps increases, thereby reducing the efficiency in forwarding frames.

In the known frame forwarding method shown in FIG. 1, for example, the packet P(2) delivered from the network 200a to the network 200c and the packets P(1) and P(3) delivered from the network 200a to the network 200b share the same transmission line between the network switches 100a and 100b. Therefore, the transmission of the packets P(1), P(2), and P(3) between the networks 200a and 200b can be indicated as shown in FIG. 3, and the total amount of time made up by the inter-frame gaps becomes longer as the length of the packets becomes shorter, thereby reducing the data forwarding efficiency in a certain time period.

As described above, in a known frame forwarding method in an Ethernet network, inter-frame gaps must be disposed between frames, and when forwarding many small frames in a short period of time, the amount of data that can be forwarded in a certain period of time is small, thereby reducing the efficiency in forwarding data.

### SUMMARY OF THE INVENTION

Accordingly, it is an object of the present invention to provide a frame forwarding method and a network switch in which, when forwarding frames between Ethernet network nodes, frames to be forwarded in the same direction are stored during transmission of the other frames in that direction or their inter-frame gaps, packets encapsulated into the stored frames are extracted and combined into a single packet before being transmitted so as to achieve efficient frame forwarding by inhibiting an adverse influence of inter-frame gaps.

In order to achieve the above object, the present invention provides a method for forwarding frames between Ethernet network nodes in which an output queue is provided for storing frames to be forwarded in the same direction, and more than one frame stored in the output queue are combined into a single frame, and the combined frame is then transmitted to the output port corresponding to that direction.

With this configuration, packets encapsulated into a plurality of frames are stored in the output queue during transmission of the previous frames in the same direction or during their inter-frame gaps, and then combined into one packet, the combined packet being encapsulated into one frame to be transmitted. Accordingly, the amount of data that can be transmitted during a certain time period is increased by the amount equivalent to the reduced number of inter-frame gaps compared to when packets encapsulated into a plurality of frames are individually transmitted, thereby achieving more efficient frame forwarding.

### BRIEF DESCRIPTION OF THE DRAWINGS

FIG. 1 illustrates a known Ethernet frame forwarding method.

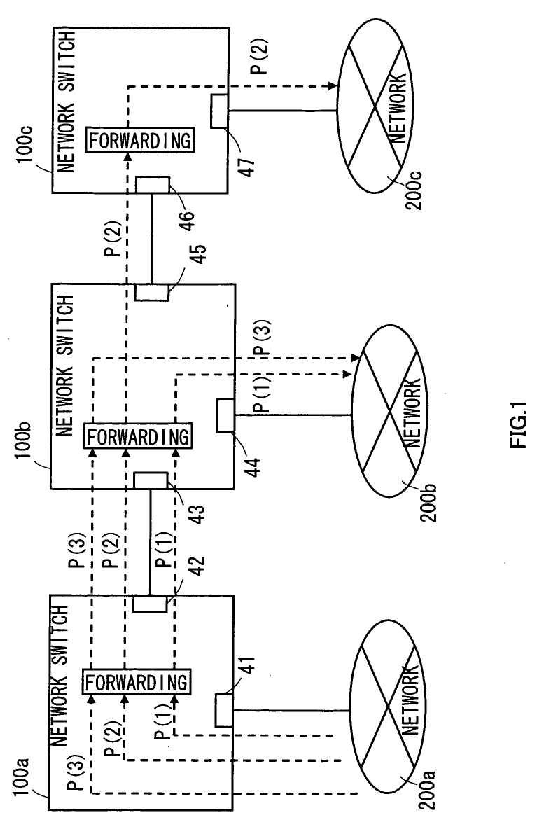

FIG. 2 illustrates the structure of an Ethernet frame in a known frame forwarding method.

FIG. 3 is a time chart illustrating a known frame forwarding method.

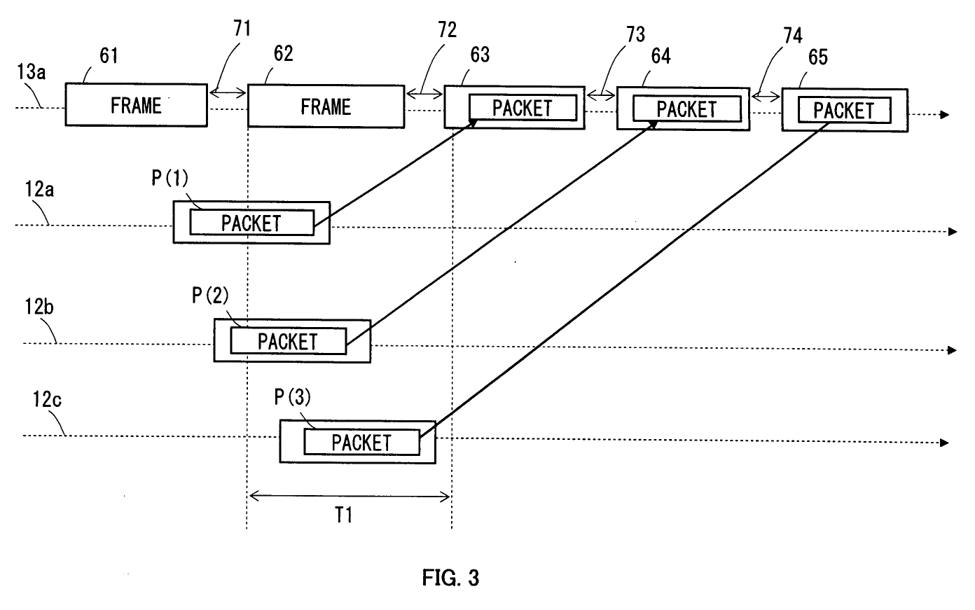

FIG. 4 is a frame forwarding method of the present invention.

FIG. 5 is a time chart illustrating the frame forwarding method of the present invention.

FIG. 6 illustrates the structure of a combined frame containing a combined packet.

FIG. 7 illustrates a function check sequence in which a network switch checks whether the other network switch implements a function of receiving and processing a combined packet configured in accordance with the present invention.

FIG. 8 illustrates the structure of the function-query/check-response packet sent from the network switches according to the present invention.

FIG. 9 is a schematic block diagram illustrating a network switch according to the present invention.

FIG. 10 is a flowchart illustrating the operation of the network switch of the present invention, and more specifically, the operation of the queuing control.

FIG. 11 is a flowchart illustrating the operation of the network switch of the present invention, and more specifically, the operation of the frame composer.

### DESCRIPTION OF THE PREFERRED EMBODIMENTS

The present invention is described in detail below with reference to the accompanying drawings through illustration of a preferred embodiment.

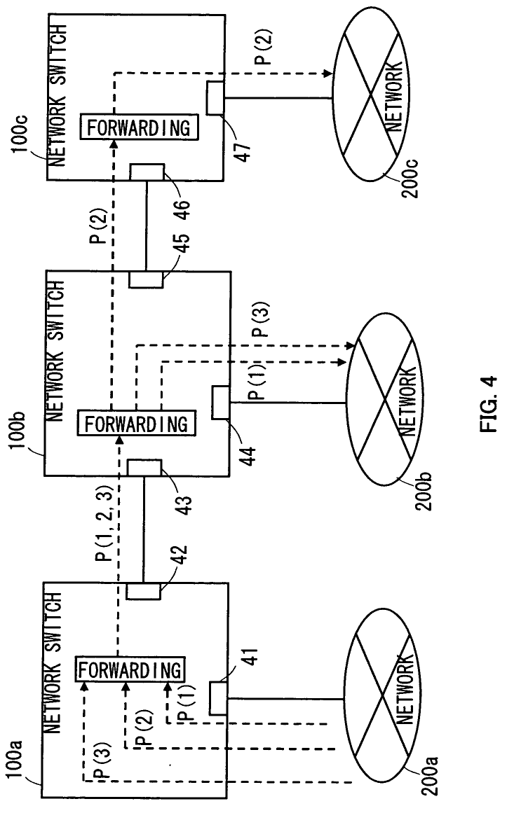

FIG. 4 is a frame forwarding method of the present invention. In FIG. 4, packets P(1) and P(3) are to be delivered from the network 200a to the network 200b, and a packet P(2) is to be delivered from the network 200a to the network 200c. In this case, the forwarding paths of the packets P(1), P(2), and P(3) are indicated by the arrows in broken lines. In FIG. 4, only the packets are shown, though they are actually encapsulated into frames.

Upon receiving the packets P(1), P(2), and P(3) via the input port 41, the network switch 100a specifies the forwarding output port corresponding to the forwarding direction by referring to the routing table based on the destination addresses set in the headers of the packets P(1), P(2), and P(3). In this case, since the forwarding directions of the three packets P(1), P(2), and P(3) are the same and correspond to the output port 42, the packets P(1), P(2), and P(3) are combined into a signal packet P(1,2,3) and are encapsulated into one combined frame. Then, the combined frame is transmitted to the output port 42 with a predetermined inter-frame gap.

Upon receiving the frame containing the packet P(1,2,3) forwarded from the network switch 100a via the input port 43, the network switch 100b extracts the packets P(1), P(2), and P(3) from the combined packet P(1,2,3). The network switch 100b specifies the forwarding output ports by referring to the routing table based on the destination addresses set in the headers of the packets. In this case, since the destination addresses of the packets P(1) and P(3) are the network 200b, the network switch 100b specifies the output port 44, which is linked to the network 200b, as the forwarding output port, and encapsulates the packets P(1) and P(3) into the corresponding frames and transmits them with predetermined inter-frame gaps. Meanwhile, since the destination address of the packet P(2) is the network 200c, the network switch 100b specifies the port 45, which is linked to the network 200c, as the forwarding output port, and encapsulates the packet P(2) into a frame and transmit it with a predetermined frame gap.

Upon receiving the frame containing the packet P(2) forwarded from the network switch 100b via the port 46, the network switch 100c specifies the forwarding output port by referring to the routing table based on the destination address set in the header of the packet P(2). In this case, since the destination address is the network 200c, the network switch 100c specifies the port 47 as the forwarding output port, and encapsulates the packet P(2) into a frame and transmit it to the output port 47 with a predetermined inter-frame gap.

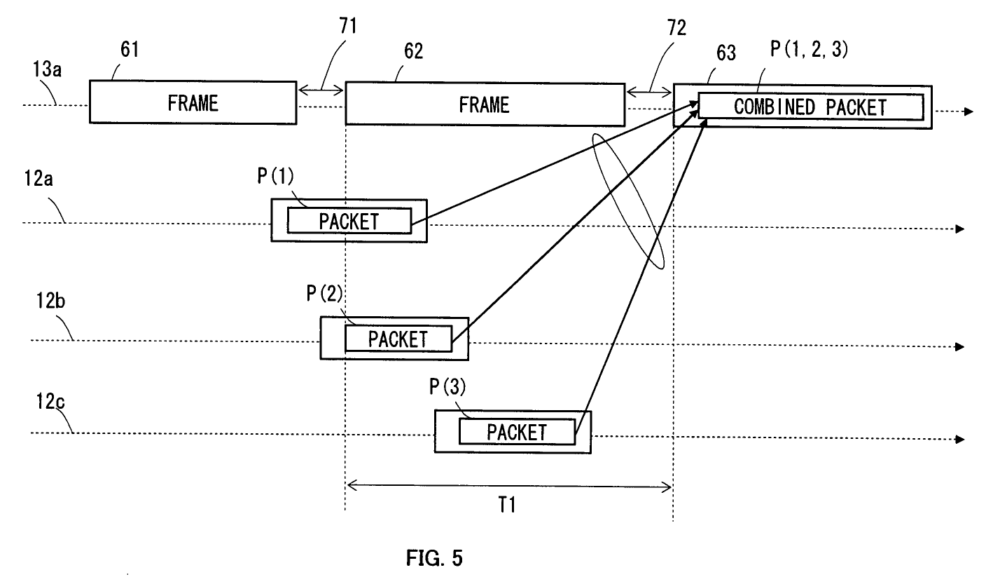

FIG. 5 is a time chart illustrating the frame forwarding method of the present invention. In FIG. 5, the packets P(1), P(2), and P(3) encapsulated into the frames received from the input ports 12a, 12b, and 12c, respectively, are combined into the single packet P(1,2,3) within the frame 63, and the frame 63 is transmitted from the output port 13a.

Frames 61, 62, and 63 transmitted from the transmission port 13a are transmitted with the inter-frame gaps 71 and 72 according to the Ethernet standards. The packets P(1), P(2), and P(3) contained in the frames received by the input ports 12a, 12b, and 12c, respectively, are combined into one packet P(1,2,3) in a time period T1 shown in FIG. 5 from when the transmission of the frame 62 is started to when the transmission of the frame 63 is started, and then, the combined packet P(1,2,3) is encapsulated as the data field of the frame 63 before being transmitted.

For combining packets, a timer monitor for monitoring an output queue and inter-frame gaps is provided for each output port, and when the timer monitor reaches a predetermined time, packets are extracted from a plurality of frames stored in the output queue and are combined into one packet. In this case, the possible number of packets that can be combined into one packet is controlled so that the length of the combined packet can be maximum within a predetermined value, and frames corresponding to the determined number of packets are extracted from the head of the output queue.

Accordingly, the packets within the frames stored in the output queue are combined into one packet, the frames being stored within a time period including an inter-frame gap, the time period being from when the transmission of one frame is started to when the transmission of the subsequent frame is started, the combined packet having the maximum length within 1500 bytes allowed in the Ethernet standards. As a result, packets can be efficiently forwarded while ensuring predetermined inter-frame gaps.

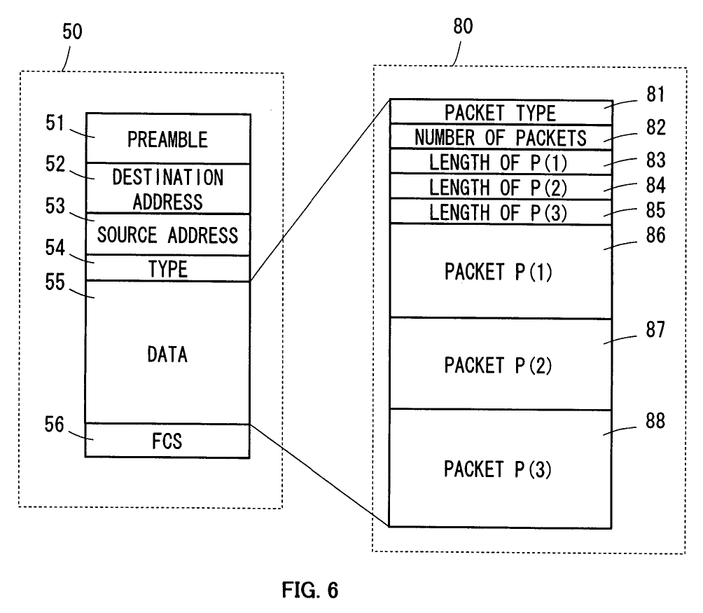

FIG. 6 illustrates the structure of a combined frame containing a combined packet.

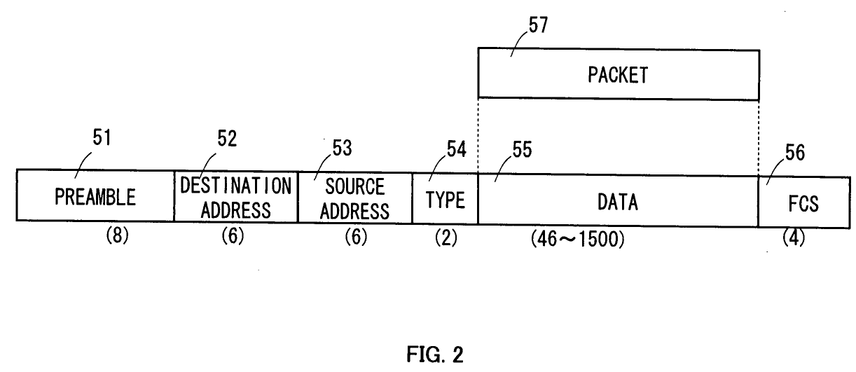

Reference numeral 50 indicates the overall structure of the frame, and the individual fields 51 through 56 are similar to those of the frame structure in a known frame forwarding method described with reference to FIG. 2, and an explanation thereof is thus omitted here. In the type 54, a predetermined ID code which is not currently assigned in the Ethernet standards is set, thereby enabling a node receiving a frame containing a combined packet to recognize that this frame is transmitted from the network switch of the present invention.

Reference numeral 80 indicates the structure of a combined packet-to be encapsulated into the data field 55 of the frame 50. In this example, the three packets P(1), P(2), and P(3) are combined into the packet 80. The packet 80 consists of a packet type 81, which is an ID code indicating that this packet is a combined packet, for example, “0” being set as the ID code, a number of packets 82 indicating the number of packets combined, lengths of packets P(1), P(2), and P(3) 83, 84, and 85, respectively, and the packets P(1), P(2), and P(3) themselves 86, 87, and 88, respectively, combined into the packet 80. The lengths of packets P(1), P(2), and P(3) 83, 84, and 85 are disposed such that they can be associated with the packets P(1), P(2), and P(3) 86, 87, and 88, respectively. With this arrangement, when extracting the individual packets from the combined packet, the addresses of the areas in which the packets before being combined are stored can be easily calculated.

In FIG. 6, the number of packets combined is three by way of example. When the number of packets to be combined is four or more, the structure of the frame and that of the combined packet are similar to those shown in FIG. 6. In this case, the total length of the combined packet must also be adjusted to be the maximum allowable packet length defined in the Ethernet standards, which is 1500 bytes.

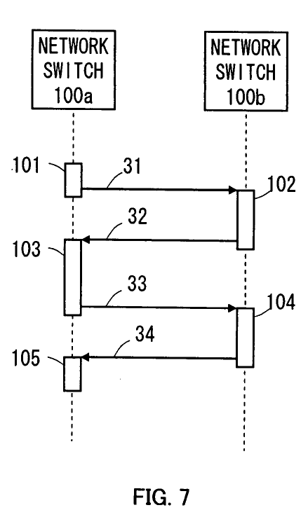

FIG. 7 illustrates a function check sequence in which the network switch 100a checks whether the network switch 100b implements a function of receiving and processing a combined packet configured in accordance with the present invention. At the start of this sequence, the Ethernet address of the network switch 100b is unknown to the network switch 100a.

In step 101, when a request to send data to the network switch 100b, which is a node whose Ethernet address is unknown to the network switch 100a, is generated, the network switch 100a first sends an address resolution protocol (ARP) packet 31 to the network switch 100b according to the known ARP protocol in order to obtain the Ethernet address of the network switch 100b.

In step 102, upon receiving the ARP packet 31, the network switch 100b returns an ARP response packet 32, in which the Ethernet address of the network switch 100b is stored, to the network switch 100a.

In step 103, after extracting the Ethernet address of the network switch 100b from the received ARP response packet 32, the network switch 100a sends a function-query packet 33 to the network switch 100b in order to check whether the network switch 100b implements a function of receiving a combined packet configured in accordance with the present invention.

In step 104, upon receiving the function-query packet 33, if the network switch 100b implements a function of receiving a combined packet, it returns a check-response packet 34 to the network switch 100a. If the network switch 100b does not implement such a function, it does not return a check-response to the network switch 100a.

In step 105, when receiving the check-response packet 34 from the network switch 100b, the network switch 100a determines that the network switch 100b is able to receive a combined packet, and sets a forwarding mode flag provided for each output port to be ON. Thereafter, when forwarding frames to the output ports linked to the network switch 100b, the network switch 100a transmits a combined packet according to the frame forwarding method of the present invention.

If a check-response packet 34 is not returned from the network switch 100b, the network switch 100a determines that the network switch 100b is not able to receive a combined packet, and thereafter transmits frames according to a known frame forwarding method. In this case, the forwarding mode flag provided for each output port remains to be OFF, which is the initial value.

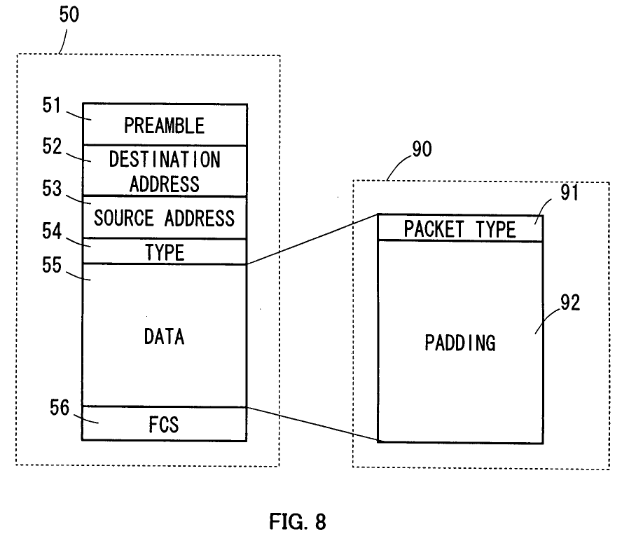

FIG. 8 illustrates the structure of the function-query/check-response packet sent from the network switches according to the present invention.

This packet is used for querying whether a network switch, serving as a node to which a frame containing this packet is to be forwarded, implements a function of receiving and processing a frame containing a combined packet, and is also used for receiving a response to this query.

Reference numeral 50 indicates the overall structure of the frame, and the individual fields 51 through 56 are similar to those of the frame structure in a known frame forwarding method described with reference to FIG. 2, and an explanation thereof is thus omitted here. The ID code set in the type 54 is the same value as the frame 50 containing combined packet shown in FIG. 6, and a predetermined code, which is unused in the Ethernet standards, is set as the ID code.

Reference numeral 90 indicates the structure of a packet to be stored in the data field 55 of the frame 50. The packet 90 includes a packet type 91, which indicates “1” when the packet 90 is a function-query packet and which indicates “2” when the packet 90 is a check-response packet returned in response to the function-query packet. The packet 90 also includes a padding 92 in which “0”s having 45 bytes are set for reserving a 46-byte area, which is the minimum value of the data field 55 defined in the Ethernet standards.

When a network switch that has sent the function-query packet receives a frame containing a check-response packet from a network switch that has received the function-query packet, the first network switch determines that the second network switch implements a function of receiving and processing a combined packet configured in accordance with the present invention.

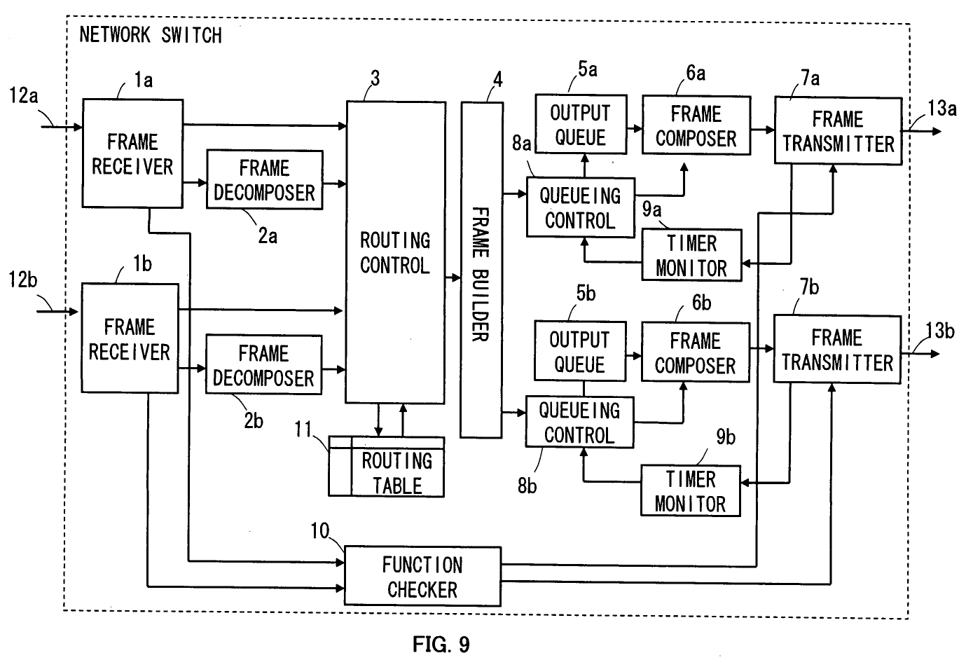

FIG. 9 is a schematic block diagram illustrating a network switch according to the present invention.

A frame receiver 1a and a frame decomposer 2a are provided for an input port 12a, while a frame receiver 1b and a frame decomposer 2b are provided for an input port 12b. A structure similar to the above structure applies when three or more input ports are provided.

An output queue 5a, a frame composer 6a, a frame transmitter 7a, a queuing control 8a, and a timer monitor 9a are provided for a output port 13a, while an output queue 5b, a frame composer 6b, a frame transmitter 7b, a queuing control 8b, and a timer monitor 9b are provided for a output port 13b. A structure similar to the above structure applies when three or more output ports are provided.

In this example, for clearly indicating the process flow, the input ports and the output ports are shown separately. In actuality, however, the same port serves as a transmission port and a reception port.

The frame receiver 1a determines the type field of a frame received from the input port 12a, and if the type field is not a predetermined ID code defined in the present invention, the frame receiver 1a determines that the frame is an Ethernet frame according to a known frame forwarding method. The frame receiver 1a then delivers the packet within the received frame to a routing control 3, and performs a routing resolution on the packet according to the known frame forwarding method.

If the above-described type field is a predetermined ID code defined in the present invention, the frame receiver 1a extracts a packet encapsulated in the data field of the received frame, and determines the packet type.

If the packet type is “0”, the packet is found to be a combined packet configured in accordance with the present invention. The frame receiver 1a thus delivers the received frame to the frame decomposer 2a.

The frame decomposer 2a extracts the packet encapsulated into the data field of the received frame so as to rearrange the order of the packets before being combined, and then delivers the rearranged packets to the routing control 3.

If the packet type is “1”, the packet is found to be a function-query packet. Then, the frame receiver 1a delivers the received frame to a function checker 10.

If the packet type is “2”, the packet is found to be a check-response packet returned in response to a function-query packet. Then, the frame receiver 1a delivers the received frame to the function checker 10.

When receiving a frame from the input port 12b, the frame receiver 1b and the frame decomposer 2b perform processing similar to that when a frame is received from the reception port 12a. A structure similar to the above structure applies when three or more reception ports are provided. In the following description, it is now assumed that the frame has been received from the input port 12a.

The routing control 3 specifies the address of the subsequent forwarding node and the forwarding output port by referring to a routing table 11 based on the address set in the header of the packet delivered from the frame receiver 1a and the frame decomposer 2a, and thereafter delivers the packet, the address of the subsequent forwarding node, and the port ID information indicating the forwarding output port to a frame builder 4.

The frame builder 4 encapsulates the packet into a forwarding frame, the forwarding frame having the packet delivered from the routing control 3 as a data field, the header of the forwarding frame having the forwarding node address delivered from the routing control 3 as the Ethernet destination address. The frame builder 4 then delivers the forwarding frame to the queuing control 8a corresponding to the port ID information delivered from the routing control 3.

After receiving the forwarding frame from the frame builder 4, the queuing control 8a extracts the length of the packet encapsulated into the data field of the forwarding frame, and stores data in which the packet length is added to the head of the forwarding frame in the output queue 5a. The packet length can be extracted by, for example, referring to the packet length set in the header of the packet encapsulated into the forwarding frame.

Simultaneously with storing the forwarding frame in the output queue 5a, a packet counter, which is retained in the output queue 5a and indicates the number of packets to be combined, is updated. The number of packets to be combined represents the number of packets to be extracted from the head of the output queue 5a so that the length of the combined packet become maximum within the packet length defined in the Ethernet standards.

Then, it is determined whether the timer monitor 9a detects that the time is up, and if so, the frame composer 9a is driven. Accordingly, the transmission of frames is suspended during a time period from when the transmission of a frame is started to when the transmission of the subsequent frame is started, the time period including an inter-frame gap, and instead, a frame encapsulating a combined packet can be forwarded while ensuring an inter-frame gap defined in the Ethernet standards.

The output queue 5a is a buffer area in which forwarding frames with packet lengths delivered from the queuing control 8a are stored in the First-In First-Out (FIFO) method. That is, the latest forwarding frame with the packet length delivered from the frame builder 4a is stored at the tail of the output queue 5a, and the frame composer 6a sequentially extracts the forwarding frames from the head of the output queue 5a. The output queue 5a also retains a packet counter in which the number of packets to be combined is stored, a packet-length counter in which the length of a combined packet is stored, and a forwarding mode flag indicating whether a forwarding node implements a function of receiving and processing a combined packet.

The frame composer 6a is driven by the queuing control 8a. When the forwarding mode flag indicates OFF, that is, when a node linked to the output port 13a does not implement a function of receiving and processing a combined packet, the frame composer 6a extracts one forwarding frame from the output queue 5a and delivers it to the frame transmitter 7a. When the forwarding mode flag is ON, that is, when a node linked to the transmission port 13a implements a function of receiving and processing a combined packet, the frame composer 6a performs packet combining processing, which is described in detail below. Accordingly, even in a network including two different types of nodes, i.e., nodes that can process combined packets and nodes that cannot process combined packets, frame forwarding can be selectively performed according to the function implemented by the node. Thus, a network can be flexibly constructed and managed.

Details of the above-described packet combining processing are as follows. When two or more forwarding frames are stored in the output queue 5a, they are sequentially extracted from the head of the output queue 5a, and the packet lengths and the packets encapsulated into the data fields of the extracted forwarding frames are arranged into one packet in the order in which they are extracted, as indicated in the data field of the frame structure shown in FIG. 6. In this case, the same number of forwarding frames as the number of packets to be combined stored in the output queue 5a are extracted from the head of the output queue 5a. With this arrangement, the length of the combined packet can be the maximum allowable packet length, which is 1500 bytes, defined in the Ethernet standards, thereby implementing efficient frame forwarding. The combined packet is encapsulated into a frame called a combined frame, and is then delivered to the frame transmitter 7a.

If only one forwarding frame is stored in the output queue 5a, it is not necessary to combine packets, and thus, the forwarding frame is directly delivered to the frame transmitter 7a.

The frame transmitter 7a transmits the delivered frame to the output port 13a, and simultaneously, it informs the timer monitor 9a that the frame transmission has been completed.

When being informed of the completion of the frame transmission, the timer monitor 9a starts a timer having a predetermined value. When the predetermined value has elapsed, the timer monitor 9a stops the timer by informing the queuing control 8a that the time is up. This value is set to be minimum of the inter-frame gap defined in the Ethernet standards.

In the above-described example, a description has been given of the operations of the output queue 5a, the frame composer 6a, the frame transmitter 7a, the queuing control 8a, and the timer monitor 9a when forwarding a frame to the output port 13a. When forwarding a frame to the output port 13b, the operations of the output queue 5b, the frame composer 6b, the frame transmitter 7b, the queuing control 8b, and the timer monitor 9b are similar to those of the corresponding counterparts. A structure similar to the above structure applies when three or more transmission ports are provided.

The function checker 10 determines the type of packet in the frame delivered from the frame receiver 1a or 1b. If the packet type is found to be a function-query packet, the function checker 10 stores a check-response packet in the data field of the frame in which a predetermined ID code is set as the type field, the frame having the source address of the received frame as the destination address, and delivers the frame to the frame transmitter corresponding to the port through which the function-query packet has been received. Accordingly, the check-response packet is returned to the node, i.e., the network switch, which has transmitted the function-query packet.

If the packet type in the frame delivered from the frame receiver 1a or 1b is a check-response packet returned in response to a function-query packet, the function checker 10 determines that the node that has transmitted the frame is a network switch implementing a function of receiving and processing a combined packet, and sets the transfer mode flag in the output queue corresponding to the output port linked to the node to be ON. By referring to this forwarding mode flag, a determination can be made whether packets are to be combined. Accordingly, even in a network including two different types of nodes, i.e., nodes that can process combined packets and nodes that cannot process combined packets, the two types of nodes can be automatically distinguished, thereby making it possible to perform frame forwarding suitable for a function implemented by a destination node.

The routing table 11 is a known table in which a destination address stored in the header of a packet encapsulated into a frame, an Ethernet address (MAC address) of a node to which the frame is subsequently forwarded, and the port ID information indicating a forwarding output port are associated with each other. Accordingly, by searching the routing table 11 by using the packet destination address as the key, the Ethernet address of the forwarding node and the forwarding output port can be specified.

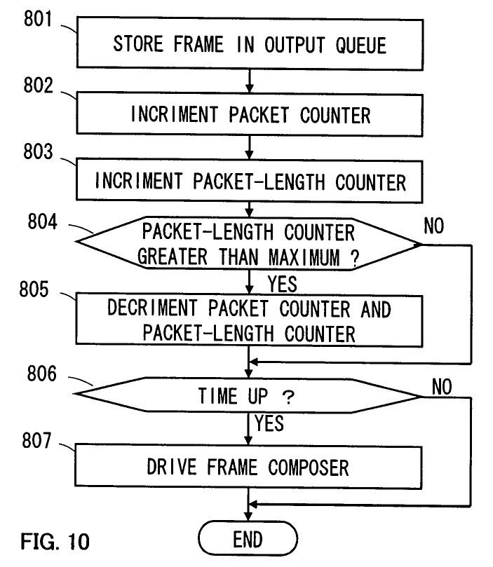

FIG. 10 is a flowchart illustrating the operation of the network switch of the present invention, and more specifically, the operation of the queuing control 8a or 8b.

In step 801, the length of a packet encapsulated into a frame delivered from the frame builder 4 is extracted, and the extracted packet length is added to the head of the frame. The frame is then stored in the output queue 5a.

In this case, when the packet is an Internet protocol (IP) packet, the packet length can be extracted by referring to, for example, an IP packet length field set in the header of the encapsulated packet.

In step 802, the packet number counter stored in the output queue counts up.

In step 803, the packet length extracted in step 801 is added to the packet-length counter stored in the output queue.

In step 804, it is determined whether the packet-length counter indicates a value greater than a predetermined value. If the outcome of step 804 is YES, the process proceeds to step 805. If the result of step 804 is NO, the process proceeds to step 806.

In step 805, “1” is subtracted from the packet counter, and also, the packet length added in step 803 is subtracted from the packet-length counter. Therefore, the packet counter can retain the maximum allowable number of packets to be extracted from the output queue by the frame composer for combining packets, enabling the packet-length counter to have the maximum allowable length of the combined packet.

In step 806, it is determined whether the timer monitor detects that the time is up. If the outcome of step 806 is YES, the process proceeds to step 807. If the result of step 806 is NO, the processing is completed. Then, the timer value in the timer monitor is set to be minimum of the inter-frame gap defined in the Ethernet standards. Accordingly, frame forwarding can be implemented while ensuring proper inter-frame gaps.

In step 807, the frame composer is driven, and the processing is completed.

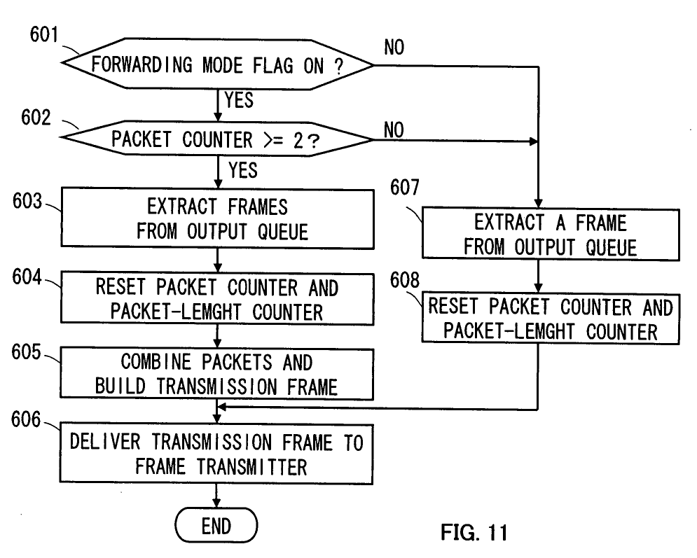

FIG. 11 is a flowchart illustrating the operation of the network switch of the present invention, and more specifically, the operation of the frame composer 6a or 6b.

In step 601, it is determined whether the forwarding mode flag is ON or OFF. If the forwarding mode flag is ON, it means that the forwarding node is a network switch constructed in accordance with the present invention. Accordingly, the process proceeds to step 602. If the forwarding mode flag is OFF, it means that the forwarding node is a known network switch. Thus, the process proceeds to step 607.

Thus, even in a network in which there are two types of network switches, i.e., network switches constructed in accordance with the present invention and network switches constructed in accordance with a known frame forwarding method, suitable frame forwarding can be performed.

In step 602, it is determined whether two or more frames are stored in the output queue, that is, whether the packet counter indicates “2” or more. If the outcome of step 602 is YES, it means that packets can be combined, and the process proceeds to step 603. If the result of step 602 is NO, it means that packets cannot be combined, and the process proceeds to step 607.

In step 603, the number of frames indicated by the packet counter are extracted from the output queue, and the packet length added to each frame and the packet encapsulated into each frame are extracted and stored in a temporary memory area. The packet counter has the number of packets to be extracted from the output queue, the packets being combined into a combined packet, the combined packet having the maximum allowable length defined in the Ethernet standards. Accordingly, encapsulating the combined packet into a frame allows most efficient frame forwarding.

In step 604, the packet counter and the packet-length counter are reset.

In step 605, based on the packet lengths and the packets stored in step 603, a combined packet, such as that shown in FIG. 6, is formed, and is encapsulated into the data field of the frame.

In step 606, the resulting transmission frame is delivered to the frame transmitter, and then, the processing is completed.

On the other hand, in step 607, the single frame is extracted from the output queue and is used as the transmission frame. If there is no frame in the output queue, the processing is completed.

In step 608, the packet counter and the packet-length counter are reset, and the process proceeds to step 606.

In the above-described embodiment of the present invention, the number of network switches, which serve as network nodes, are three, the number of packets are three, and the number of networks, which serve as the sources and the destinations of the packets, are three. However, the numbers of network switches, packets, and networks are not particularly restricted.

The configurations of the network switches, combined packets, and function-query/check-response packets are not restricted to those described in the above embodiment. Various modifications can be made on these configurations, and they are not limitations of implementing the present invention.

1. A method of frame forwarding in an Ethernet network, comprising the steps of:
receiving a frame from an input port, said frame containing a packet;
determining an output port coupled with a destination node of said packet via a data path;
building a forwarding frame containing said packet;
storing said forwarding frame in an output queue corresponding to said output port;
combining a plurality of forwarding frames stored in said output queue into a combined frame; and
transmitting said combined frame to said output port.

2. The method of claim 1, further comprising the steps of:
preparing a routing table, each entry of said routing table containing a destination address value indicating a destination node of said packet, a port ID value indicating said output port, and a forwarding address value;
extracting a destination address value from said packet contained in said frame;
looking up said destination address value in said routing table;
determining said port ID value and said forwarding address value corresponding to said destination address value;
building a forwarding frame with a header field and a data field, said header field containing said forwarding address value as a destination address, said data field containing said packet; and
storing said forwarding frame into said output queue corresponding to said output port.

3. The method of claim 1, further comprising the steps of:
extracting a plurality of forwarding frames from said output queue,
combining each packet contained in each of said forwarding frames into one combined packet;
building a combined frame containing said combined packet as a data field, said combined frame having a header including a predetermined ID value, said predetermined ID value indicating that said-combined frame contains said combined packet; and
transmitting said combined frame to said output port.

4. The method of claim 1, further comprising the steps of:
receiving said combined frame from said input port;
extracting said combined packet from said combined frame;
decomposing said combined packet to original packets;
determining said output port coupled with destination node of each of said original packets via said data path;
building said forwarding frame containing each of said original packets; and
storing said forwarding frame in said output queue corresponding to said output port.

5. The method of claim 3, further comprising the steps of:
preparing a packet counter in said output queue, said packet counter indicating a number of packets to be combined wherein a size of said combined packet does not exceed the maximum data field size defined in Ethernet;
combining a plurality of packets contained in said plurality of forwarding frames stored in said output queue into said combined packet, wherein said plurality of packets are combined in queuing order and the number of packets combined is equal to said packet counter.

6. The method of claim 5, wherein said combined packet has a following data allocation:
(1) the number of packets to be combined,
(2) a sequence of size values of original packets, and
(3) a sequence of original packets,
wherein said sequence of size values of said original packets are allocated in the same order as said sequence of said original packets.

7. The method of claim 3, further comprising the steps of:
preparing a timer monitor corresponding to said output queue, said timer monitor having a timer with a predetermined expiring time;
activating said timer at a completion of frame transmission;
suspending composition and transmission of forwarding frames stored in said output queue while said timer is active;
executing composition and transmission of said forwarding frames at expiration of said predetermined expiring time.

8. The method of claim 7, further comprising the steps of:
setting said predetermined expiring time for the minimum time value of the inter-frame gap defined in Ethernet.

9. The method of claim 1, further comprising the steps of:
transmitting to a forwarding node a query frame, said query frame including a function-query packet for querying whether said forwarding node is available for processing said combined frame;
receiving a response frame from said forwarding node, said response frame including a check-response packet indicating that said forwarding node is available for processing said combined frame; and
determining that said forwarding node is available for processing said combined frame.

10. A method of frame forwarding in an Ethernet network, comprising the steps of:
forming a plurality of output queues which are including a plurality of frames to be sent from same port, respectively;
combining said plurality of frames in one of said plurality of output queues into a combined frame; and
transmitting said combined frame from a corresponding port.

11. A network switch for frame forwarding in an Ethernet network, comprising:
a frame receiver for receiving a frame from an input port, said frame containing a packet;
a routing means for determining an output port coupled with a destination node of said packet via a data path;
a frame builder for building a forwarding frame containing said packet;
an output queue for storing said forwarding frame, said output queue corresponding to said output port;
a frame composer for combining a plurality of forwarding frames stored in said output queue into a combined frame; and
a frame transmitter for transmitting said combined frame to said output port.

12. A network switch of claim 11, wherein said routing means comprising:
a routing table for recording forwarding information entries, each of said forwarding information entries containing a destination address value indicating a destination node of said packet, a port ID value indicating said output port, and a forwarding address value indicating a frame forwarding node; and
a routing control for determining said port ID value and said forwarding address by looking up said destination address value in said routing table.

13. A network switch of claim 11, wherein said frame composer extracts said forwarding frames from said output queue, combines each packet contained in each of said forwarding frames into a combined packet, and builds said combined frame containing said combined packet as a data field, said combined frame having a header including a predetermined ID value, said predetermined ID value indicating that said combined frame contains said combined packet.

14. A network switch of claim 11, further comprising:
a frame decomposer for decomposing said combined packet contained in said frame received from said input port to original packets, said original packets being processed by said routing means.

15. A network switch of claim 13, wherein said output queue has a packet counter indicating the number of packets to be combined, and a plurality of packets contained in said plurality of forwarding frames stored in said output queue are combined into said combined packet in queuing order wherein the number of packets combined is equal to said packet counter, and a size of said combined packet does not exceed the maximum data field size defined in Ethernet.

16. A network switch of claim 15, wherein said combined packet including: (1) the number of packets to be combined, (2) a sequence of size values of original packets, and (3) a sequence of said original packets wherein said sequence of size values of said original packets are disposed in the same order as said sequence of said original packets.

17. A network switch of claim 11, further comprising:
a timer monitor for controlling composition and transmission of said forwarding frames stored in said output queue, said timer monitor having a timer with a predetermined expiring time, said timer being activated at a completion of frame transmission, said timer monitor suspending composition and transmission of said forwarding frames while said timer is active, said timer monitor executing composition and transmission of said forwarding frames at expiration of said predetermined expiring time.

18. A network switch of claim 17, wherein said predetermined expiring time is set for the minimum time value of the inter-frame gap defined in Ethernet.

19. A network switch of claim 11, further comprising:
a function checker for determining whether a forwarding node is available for processing said combined frame, said function checker transmitting to said forwarding node a frame including a function-query packet for querying whether said forwarding node is available for processing said combined frame, said function checker receiving from said forwarding node a response frame including a check-response packet indicating that said forwarding node is available for processing said combined frame.

20. A network switch for frame forwarding in an Ethernet network, comprising:
an output queue for storing a plurality of frames to be sent from a port;
means for combining said plurality of frames in said output queue into a combined frame; and
means for transmitting said combined frame from said port.
